(19) United States
(12) Patent Application Publication
(10) Pub. No.: US 2013/0095444 A1
(43) Pub. Date: Apr. 18, 2013

(54) PREHEATER SHELL TEMPERATURE REGULATOR

(71) Applicants: Niels Agerlund Christensen, Slagelse (DK); Lars Skaarup Jensen, Vallensbaek (DK); Karl Emil Andreas Strömberg, Sodra Sandby (SE)

(72) Inventors: Niels Agerlund Christensen, Slagelse (DK); Lars Skaarup Jensen, Vallensbaek (DK); Karl Emil Andreas Strömberg, Sodra Sandby (SE)

(73) Assignee: FLSMIDTH A/S, Valby (DK)

(21) Appl. No.: 13/704,817

(22) PCT Filed: Jun. 22, 2011
(86) PCT No.: PCT/IB2011/001427

§ 371 Date: Dec. 17, 2012

(30) Foreign Application Priority Data
Jun. 22, 2010 (DK) PA 2010 00546

(51) Int. Cl. F27D 1/12

(52) U.S. Cl. CPC F27D 1/12
USPC 432/249; 432/252

(57) ABSTRACT

A description is given of a heat treatment apparatus, such as a preheater or calciner (1) for heat treating cement raw materials, said heat treatment apparatus comprising a heat treatment compartment being defined by a metal casing (5), which may have on its inner side layers of refractory lining material (3) and insulation material (4). The apparatus is peculiar in that the metal casing (5) is provided with an external insulation (6) comprising an innermost insulation layer (6a) and at least one outer insulation layers (6b), each insulation layer (6a, 6b) comprising a number of shield elements (7) having a top end (8) and a bottom end (9), where the insulation layers are arranged at different distances from the metal casing (5), thus providing an inner air space (11) between the innermost insulation layer (6a) and the metal casing (5) and at least one outer air space (10) between the innermost insulation layer (6a) and an outer insulation layer (6b), where the metal casing (5) furthermore is provided with a bottom element (17) being connected to and extending outwards from the metal casing (5) at a distance below the bottom end (9) of the innermost insulation layer (6a), thus providing an opening (18) between the inner and outer air spaces (11, 10), where at least one of the outer insulation layers is connected to the bottom element (17) at its bottom end (9).

Hence it will be possible to obtain a heat treatment apparatus, which may be better internally insulated to reduce the energy loss, while at the same time the metal casing temperature may be regulated both to avoid overheating and corrosion problems. The corrosion problems are avoided by preheating the air in an outer air space before it enters the inner air space, thus ensuring that the metal casing temperature is kept above the critical dew point temperature, where the acids do not condensate on the inner side of the metal casing but will be part of the gas stream leaving the heat treatment apparatus, whereas overheating of the metal casing is avoided by way of the heat exchange taking place between the heated air flowing in the inner air space and the air flowing in the outer air space, where the latter thus being preheated.

The present invention relates to a heat treatment apparatus, such as a preheater or calciner for heat treating cement raw materials, said heat treatment apparatus comprising a heat treatment compartment being defined by a metal casing, which may have on its inner side layers of refractory lining material and insulation material.

Heat treatment apparatuses of the above mentioned kind are well known in e.g. the cement manufacturing industry. The heat treatment process of e.g. cement raw materials is typically associated with emission of acids gases, such as SO₂, SO₃, HCL and H₂S, which may pass through the refractory and insulation materials to the metal casing, where they may condense on the inner side of the metal casing if the temperature of this is to low, thus giving rise to corrosion problems. The corrosion problem may simply be solved by increasing the metal casing temperature to well above the critical dew point temperature, thus the acids will remain in the gas phase and be part of the gas stream leaving the heat treatment apparatus or will react with reactants within the apparatus. One way of increasing the metal casing temperature is by using a less insulating internal insulation. However, the disadvantage of such a solution is the higher energy loss. Another way is to provide the heat treatment apparatus with an external insulation; however, this solution may under alternating temperature and wind conditions led to overheating of the metal casing. Further, outside insulation may give rise to corrosion on outer side of the metal casing in cases where the apparatus is not in operation.

From U.S. Pat. No. 4,020,772 it is further known to provide a wall element in short distance from the metal casing of a heat treatment device in such a way that ambient air is allowed to be drawn up through the gap between the metal casing and the wall element, thus cooling down the metal casing in controlled manner. However, practical use of such a system has shown great problems in maintaining proper temperatures of the metal casing, which in fact was cooled too much at the bottom section, thus causing heavy corrosion problems, and too little at the top section, thus causing overheating of the metal casing.

It is the objective of the present invention to provide a heat treatment apparatus, whereby the aforementioned disadvantage is eliminated or at least significantly reduced.

According to the present invention this is achieved by an apparatus of the kind mentioned in the introduction, and being characterized in that that the metal casing is provided with an external insulation comprising an innermost insulation layer and at least one outer insulation layers, each insulation layer comprising a number of shield elements having a top end and a bottom end, where the insulation layers are arranged at different distances from the metal casing, thus providing an inner air space between the innermost insulation layer and the metal casing and at least one outer air space between the innermost insulation layer and an outer insulation layer, where the metal casing furthermore is provided with a bottom element being connected to and extending outwards from the metal casing at a distance below the bottom end of the innermost insulation layer, thus providing an opening between the inner and outer air spaces, where at least one of the outer insulation layers is connected to the bottom element at its bottom end.

Hence it will be possible to obtain a heat treatment apparatus, which may be better internally insulated to reduce the energy loss, while at the same time the metal casing temperature may be regulated both to avoid overheating and corrosion problems. The corrosion problems are avoided by preheating the air in an outer air space before it enters the inner air space, thus ensuring that the metal casing temperature is kept above the critical dew point temperature, where the acids do not condensate on the inner side of the metal casing but will be part of the gas stream leaving the heat treatment apparatus, whereas overheating of the metal casing is avoided by way of the heat exchange taking place between the heated air flowing in the inner air space and the air flowing in the outer air space, where the latter thus being preheated.

As the air flow through the air spaces under certain conditions may be too high or too low, thus cooling the metal casing more respective less than required, it is preferred that the apparatus comprises means for regulating the air flow through the air spaces.

Such means for regulating the air flow through the air spaces and thus the temperature prevailing in the air spaces may be made in any appropriate manner. Thus the regulation means may be adjustable, where, in one embodiment, the means may be made to offer the possibility of varying the width of the air spaces e.g. by varying the distance between the shield elements and the metal casing, whereas in another embodiment the air flow regulation means may be fitted in the air spaces or at one of their ends. In both embodiments the air flow velocity in the air spaces and thus the temperature may be regulated.

The adjustable air flow regulation means may comprise hinged baffle plates, the angular position of which may be individually or collectively adjusted by means of appropriate actuator or force means in order to regulate the air flow through the air spaces.

In a preferred embodiment the hinged baffle plates are mounted at the top end of the air spaces and the corresponding shield elements.

The actuator or force means may be driven by external equipment or they may be of the temperature controlled type having a piston in a cylinder, where the internal pressure, which is determined by the temperature, controls the actual position of the piston. The actuator may also be of the bi-metallic type where the relative expansion due to temperature changes enforces a movement.

The shield elements of the insulation layers may be made in any suitable material and form that ensures the necessary degree of insulation and durability to withstand variations in the weather conditions. In a preferred embodiment the shield elements are made of aluminium stainless steel sheets which preferably are corrugated in order to increase their strength.

The individual insulation layers are arranged in an appropriate distance from the metal casing by means of any suitable distance elements, thus providing an air space between the innermost insulation layer and the metal casing and an air space between the innermost insulation layer and the outer insulation layer. The distance elements may be securely fastened to the metal casing or to the inward adjacent insulation layer in any suitable manner, such as by welding, bolting etc. Likewise, the shield elements of the insulation layers may be securely fastened to the distance elements in any suitable manner, however screw joints are preferred for easy replacement.

The invention will now be described in further details with reference to the drawing; being diagrammatical, and showing in

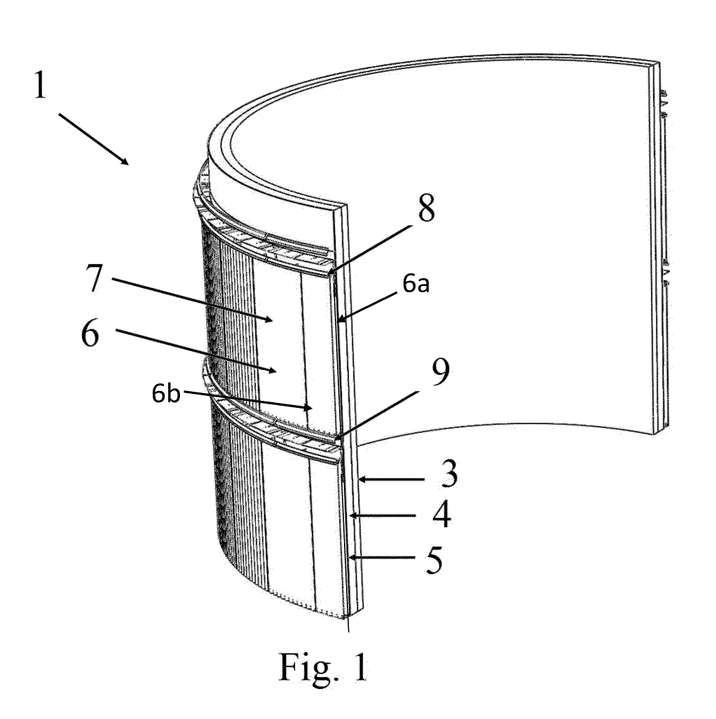

FIG. 1 a sectional view of a calciner provided with an external insulation according to the invention,

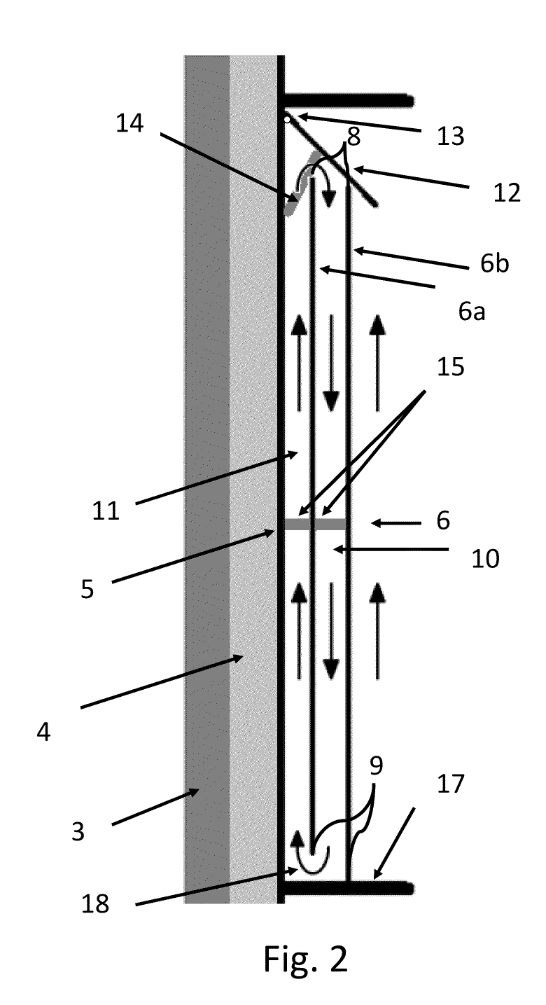

FIG. 2 a sectional view of a preferred embodiment of the external insulation according to the invention with adjustable air flow regulating hinged baffle plates in their closed position, and

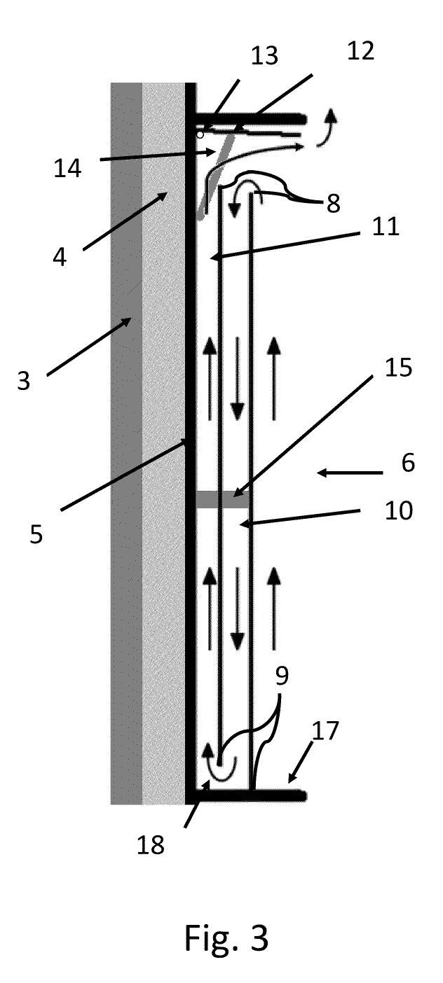

FIG. 3 the same embodiment as in FIG. 2, but with the adjustable air flow regulating hinged baffle plates in their fully open position.

In FIG. 1 is shown a sectional view of a heat treatment apparatus in form of a calciner 1 for heat treating cement raw materials. The calciner 1 comprises an inner refractory lining 3, an inner insulation layer 4 and a metal casing 5.

When operating the calciner 1 for calcination of cement raw materials emissions of acids gases, such as SO₂, SO₃, HCL and H₂S, are normally formed, which gases may pass through the refractory and insulation materials 3, 4 to the metal casing 5, where they may condense on the inner side of the metal casing 5 if the temperature of this is to low, thus giving rise to corrosion problems.

To avoid corrosion problems to occur without giving rise to heavy energy loss or overheating of the metal casing 5 the heat treatment apparatus according to the invention is provided with an external insulation 6 comprising two insulation layers in form of an innermost insulation layer 6a and an outer insulation layer 6b, each insulation layer 6a, 6b comprising a number of shield elements 7 having a top end 8 and a bottom end 9. The insulation layers 6a and 6b are by means of distance elements 15 arranged at different distances from the metal casing 5, thus providing an inner air space 11 between the innermost insulation layer 6a and the metal casing 5 and an outer air space 10 between the innermost insulation layer 6a and the outer insulation layer 6b. The metal casing 5 is furthermore provided with a bottom element 17 being connected to and extending outwards from the metal casing 5 at a distance below the bottom end 9 of the innermost insulation layer 6a, thus providing an opening 18 between the inner and outer air spaces 11, 10. The outer insulation layer 6b is connected to the bottom element 17 at its bottom end 9 to avoid entrance of ambient air at this point.

The apparatus comprises means 12 for regulating the air flow through the air spaces 10 and 11 and thus the temperature prevailing in the air spaces 10 and 11. The air flow regulating means 12 in the shown embodiment comprises baffle plates 12 being retained in hinges 13 secured to the metal casing 5 and mounted at the top end of the air spaces 10 and 11 and the corresponding insulation layers 6a and 6b. In the shown embodiment the angular position of the baffle plates 12 is adjusted by means of an actuator 14 of the piston in a cylinder type in order to regulate the air flow through the air spaces 10 and 11. The baffle plates 12 may be moved variably between a closed position where the air flow into the air space 10 is blocked and the air inside the air spaces 10 and 11 due to the temperature difference between the hotter metal casing 5 and the colder outer insulation layer 6b circulate as shown by the arrows while being alternately heated in air space 11 and cooled in air space 10, and a fully open position where ambient air is drawn into and down through air space 10 while being preheated due to the indirect heat exchange with the air in air space 11, and is then drawn up through air space 11 while on the one hand being heated by the hot metal casing 5 and on the other hand being cooled due to the indirect heat exchange with the air in air space 10, where the heated air from air space 11 escape to the atmosphere at the top of air space 11.

Thus, in operation, when the temperature of the section of the metal casing behind a certain of the external insulation 6 increase, the baffle plates 12 are adjusted in direction of the fully open position, see FIG. 3, whereas the baffle plates 12 are adjusted in the opposite direction when the temperature decrease, see FIG. 2. In this way the metal casing temperature may be kept within a narrow temperature range.

1. A heat treatment apparatus, such as a preheater or calciner for heat treating cement raw materials, said heat treatment apparatus comprising a heat treatment compartment being defined by a metal casing, wherein that the metal casing is provided with an external insulation comprising an innermost insulation layer and at least one outer insulation layers, each insulation layer comprising a number of shield elements having a top end and a bottom end, where the insulation layers are arranged at different distances from the metal casing, thus providing an inner air space between the innermost insulation layer and the metal casing and at least one outer air space between the innermost insulation layer and an outer insulation layer, where the metal casing furthermore is provided with a bottom element being connected to and extending outwards from the metal casing at a distance below the bottom end of the innermost insulation layer, thus providing an opening between the inner and outer air spaces, where at least one of the outer insulation layers is connected to the bottom element at its bottom end.

2. An apparatus according to claim 1, wherein that the apparatus comprises means for regulating the air flow through the air spaces.

3. An apparatus according to claim 2, wherein that the air flow regulation means are fitted in the air spaces or at one of their ends.

4. An apparatus according to claim 3, wherein that the air flow regulation means comprises hinged baffle plates, the angular position of which may be individually or collectively adjusted by means of appropriate actuator or force means in order to regulate the air flow through the air spaces.

5. An apparatus according to claim 4, wherein the hinged baffle plates are mounted at the top end of the air spaces and the corresponding shield elements.

6. An apparatus according to claim 4, wherein the actuator or force means are of the temperature controlled type having a piston in a cylinder, where the internal pressure, which is determined by the temperature, controls the actual position of the piston.

7. An apparatus according to claim 1, wherein that the shield elements are made of aluminium or stainless steel sheets.

8. An apparatus according to claim 1, wherein that the shield elements are corrugated.

9. An apparatus according to claim 1, wherein that the shield elements are arranged in an appropriate distance from the metal casing by means of distance elements.
